(19) United States
(12) Patent Application Publication
(10) Pub. No.: US 2008/0028412 A1
(43) Pub. Date: Jan. 31, 2008

(54) METHOD FOR THE ADMINISTRATION OF RESOURCES

(75) Inventors: Wulf Harder, Riga (LV); Uwe Resas, Luneburg (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: SIA Syncrosoft, Riga (LV)

(21) Appl. No.: 11/622,139

(22) Filed: Jan. 11, 2007

(30) Foreign Application Priority Data
Jul. 26, 2006 (DE) 10 2006 035 275.0

(51) Int. Cl. G06F 9/46

(52) U.S. Cl. 718/104

(57) ABSTRACT

A method for the administration of resources, in which classes or instances, respectively, are assigned to the resources and a program receives a rule assigned to the class or instance, respectively, and applies it to the resource. It is made sure that only rules assigned to the class or instance, respectively, are applied on the resource. In alternative methods, only rules are applied on the resource, which were accepted by a verification rule assigned to the resource.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The present invention is related to a method for the administration of resources.

Value accounts are stored on trustable computers or apparatuses. These computers or apparatuses are mostly specially provided for the storage of accounts of one special type. The software for changing the accounts is mostly installed or updated, respectively, by the owner of the computer.

When the owner of a resource, a value account for instance, is also the user of the computer and the resource is permitted to be used only according to externally defined rules however, for security reasons only computers for the administration of one kind of resource are used, and mostly all the rules for resource changing are fixed during the handoff of the computer to the user.

The present invention is based on the objective to provide methods for the administration of resources which follow dynamic, externally predetermined bodies of rules in the use or change, respectively, of the resources.

### BRIEF SUMMARY OF THE INVENTION

One class or one instance at a time is assigned to least two resources. After the assignment, a program applies only rules on the resource which are assigned to the same class or instance, respectively. The program makes sure that only rules assigned to the class or instance, respectively, are applied on the resources.

One verification rule at a time is assigned to at least two resources. A program receives a rule and examines the rule with respect to applicability on the resource with the aid of the verification rule. In the case that the examination yields the result that the rule can be applied, it is applied. The program makes sure that only rules accepted by the verification rule are applied on the resource.

The program changes the verification rule with the aid of a received and accepted rule.

One verification rule at a time is assigned to at least one resource. The program receives a rule and examines the applicability of the rule on the resource with the aid of the verification rule. In the case of a positive result, the program applies it on the resource. The program receives a further rule, which it examines with respect to acceptance with the aid of the verification rule. At proven acceptance the program changes or replaces the verification rule with the aid of the rule.

The program stores or marks rules, respectively, which were decided to be applicable on the resource with the aid of the verification rule. After change or replacement of the verification rule, the stored or marked rules are examined again with respect to the applicability on the resource with the aid of the new verification rule. The not applicable rules are removed from the memory or are marked as not applicable, or applicable rules only are marked as such. By doing so, an application of old rules can be prevented for instance, when the rules contain version information.

The program is an operating system. The computer on which the operating system is installed receives the rules.

The resource is a memory or a part of a memory.

The memory or the part of the memory, respectively, contains licensing data. These may be remaining usage times for licensed software or contents.

A rule for use or change of the resource, respectively, is described through a program.

The rule is cryptologically certified and the certificate is cryptologically examined with regard to correctness before the application.

### BRIEF DESCRIPTION OF THE SEVERAL VIEWS OF THE DRAWINGS

FIG. 1 is a schematic block diagram of a Petri net

FIG. 2 if a schematic block diagram of a Petri net.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

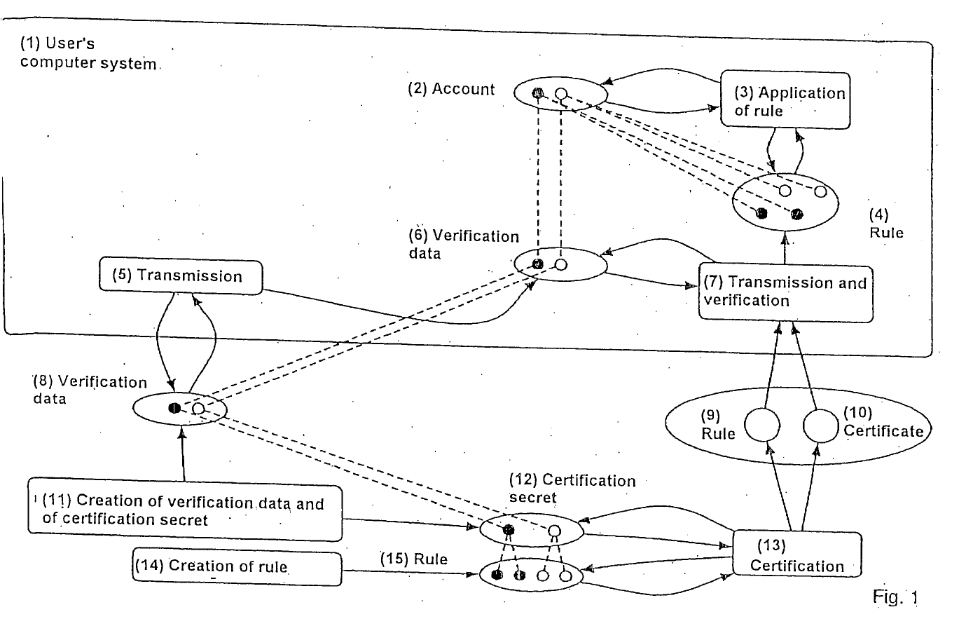

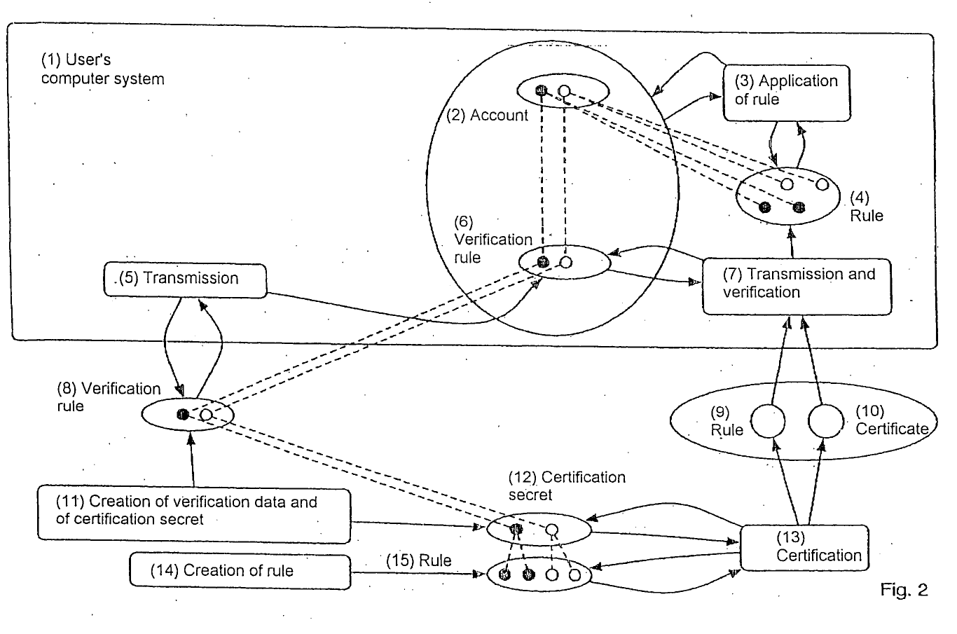

FIG. 1 or 2, respectively, represent a coloured Petri net. The difference between FIG. 1 and FIG. 2 is that in FIG. 2 the rule-application (3) can also act upon the verification rule (6), and that in FIG. 2 a verification rule (6) or (8), respectively, replaces the verification data (6) or (8), respectively, in FIG. 1.

In the first example according to FIG. 1, a resource, here an account (2) for a software licence of a software firm is to be installed and used on a user's PC (1). The account is to receive an initial value at the installation, and the value of the account is to be decremented upon every invocation of the licensed software.

The software firm (11) creates verification data (8) and a certification secret (12). The verification data (8) are transmitted (5) to the user's computer system (1).

Further, the software firm generates (14) a software with a first rule (15) for opening an account for a software licence on the user's PC (1) and it certifies (13) the first rule with the certification secret (12).

The certified rule (9) and the certificate (10) are transmitted (7) to the user's computer system (1) and verified (7) with the aid of the verification data (6). After successful verification (7), the rule is applied (3) and an account (2) is opened in the memory of the user's PC (1) and assigned to the verification data (6). The rule initialises the account (2) to the initial value. Each further rule (15) can be applied to the account (2) after certification (13), transmission and verification (7) only when it has been certified (13) with the same certification secret (12). Accounts (2) of other software films can be opened on the user's PC (1) in the same manner. All the actions on the user's PC (1) are monitored by its operating system. Each software firm can define own rules (4), which are always only applicable to accounts of the respective assigned software firm. The rule creation (14) and the certification (11) can be performed by different instances.

In the second example according to FIG. 2, a resource, here an account (2) for a software licence of a software firm is to be opened and used on a user's PC (1). The account is to receive an initial value upon its opening, and the account value is to be decremented upon every invocation of the licensed software. At a later point of time, the control of the rules with respect to the account is to be transferred to a sales firm.

The software film (11) creates a verification rule (8) and a certification secret (12) The verification rule (8) is transmitted (5) to the user's computer system (1).

Further, the software firm creates (14) a software with a first rule (15) for opening an account for a software licence on a user's PC (1) and it certifies (13) the first rule with the certification secret (12).

The certified rule (9) and the certificate (10) are transmitted (7) to the users computer system (1) and verified (7) with the aid of the verification rule (6). After successful verification, the rule is applied and an account (2) is opened in the memory of the user's PC (1) and assigned to the verification rule (6). The rule initialises the account (2) to the initial value and permits the verification rule (6) to be unchanged. Each further rule (15) can be applied to the account (2) and/or the verification rule (6) after certification (13), transmission and verification (7) only when it has been certified (13) with the same certification secret (12). For the handing-over of the control with respect to the rules to the sales firm, the software firm creates (14) a rule (15), which after certification (13), transmission and verification (7) replaces the verification rule (6) against a verification rule created by the sales firm at the application (3) of the rule. All the old rules (4) are cancelled at the rule application (3). In order to be applied on the account (2), all the further rules (4) must be certified with the certification secret (12) of the sales firm (13). Accounts or resources (2) of other instances, like software firms or banks for instance, can be opened on the user's PC (1) in the same manner. All the actions on the user's PC (1) are monitored by its operating system. Each instance can define own rules (4), which are always only applicable to resources of the respective assigned instance. The rule creation (14) and the certification (13) can be performed by different instances.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A method for the administration of resources, characterised in that at least two resources are assigned to one class or one instance at a time, respectively, and a program receives at least one rule assigned to the class or instance, respectively, the program applies the rule on a resource and the program makes sure that only rules assigned to the class or instance, respectively, are applied on the resources.

2. A method for the administration of resources, characterised in that one verification rule at a time is assigned to at least two resources and a program receives at least one rule, the program examines the rule with respect to applicability on the resource with aid of the verification rule, applies it on the resource only in the case of a positive result and the program makes sure that only rules accepted with the aid of the verification rule are applied on the resource.

3. A method according to claim 2, characterised in that the program changes or replaces a verification rule with the aid of a received and accepted rule.

4. A method for the administration of resources, characterised in that one verification rule at a time is assigned to at least one resource and a program receives at least one rule, the program examines the rule with respect to applicability on the resource with the aid of the verification rule and applies it on the resource only in the case of a positive result, a verification rule is changed or replaced with the aid of a received and accepted rule and the program makes sure that only rules accepted with the aid of the updated verification rule are applied on the resource.

5. A method according to claim 3, characterised in that rules received by the program which were decided to be applicable on the resource with the aid of a verification rule, are stored or marked, respectively, and that after change or replacement of the verification rule, the stored or marked rules are examined again with respect to their applicability on the resource with the aid of the new verification rule, wherein not applicable rules are removed from the memory or are marked as not applicable, or only applicable rules are marked as such.

6. A method according to claim 1, characterised in that the program is an operating system or part of an operating system.

7. A method according to claim 1, characterised in that a resource is a memory or a part of a memory, respectively.

8. A method according to claim 7, characterised in that the memory or the part of the memory, respectively, contains licensing data.

9. A method according to claim 1, characterised in that a rule is described through a program.

10. A method according to claim 1, characterised in that the rule is cryptologically certified and the correctness of the certificate is cryptologically examined before the application.
